(19) United States
(12) Patent Application Publication
(10) Pub. No.: US 2007/0197942 A1
(43) Pub. Date: Aug. 23, 2007

(54) Disposable, leveraged mechanical prostate massager

(76) Inventor: James Theodore Hacker, Lauderhill, FL (US)

Correspondence Address: James Theodore Hacker, 4218 Invemery Blvd. APT 94B, Lauderhill, FL, 33319, US

(21) Appl. No.: 11/356,806

(22) Filed: Feb. 17, 2006

(51) Int. Cl. A61H 19/00

(52) U.S. Cl. 601/137; 606/197

(57) ABSTRACT

My device is a disposable anal cavity prostate massager. The anal probe, with its' covering can be disposed of after use while retaining the main body of the device and the mechanical slider. It is a prostate massager with a disposable probe and covering controlled by the user by mechanical forces the amount of which is determined by the user. A prostate massager using a leveraged function to obtain movement of an anal probe in several axis of rotation separately or combined to achieve powerful ejaculations to relieve pressure, for medical purposes or just for pleasure.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to the internal massaging of the prostrate gland through external mechanical controls.

### BACKGROUND OF THE INVENTION

I invented a device which physically massages the prostate gland for medical relief of an engorged prostate gland and can also be used for simple pleasure of stimulating the gland for intense ejaculation. My invention is very simple, easy to use and cost efficient to manufacture. It gives the user complete control of the time and involvement needed to achieve the desired results. Other prostate devices only entail movement or stimulation in one or two movement axis. My invention involves movement in all three axis—up and down, forward and back, side to side as well as any combination of all three—without the use of any electrical appliance. My device is entirely operated mechanically by the user.

It is simple to operate and equally simple to disassemble for storage or travel. My invention is unique in that the anal probe and covering are easily detached and can be disposed of after use.

### BACKGROUND OF INVENTION—OBJECTS AND ADVANTAGES

My invention is a mechanical device that allows the user complete control over a selection of maneuvers, oscillations and twists by an internal probe in the anal canal massaging the male prostate gland. These movements can squeeze, push, rub or otherwise have a gentle impact on the prostate gland in order to achieve the release of seminal fluid from an unhealthy swollen prostate. Any single one of the internal movements of the probe can be initiated by the user. Or as an alternative and more complex maneuver, two or more of the movements may be combined. The device uses interlocking slides and cylinders, outside the anal cavity, to achieve the desired movement on the adjacent prostate gland from within the anal cavity. The devise uses no electric motors or batteries as do other prostate massagers in order to perform complex maneuvers. Electric motors are fragile, unreliable, and have a tendency to break after a short amount of use. Batteries wear out without warning making these devices unusable.

Electric motors, contact points, wires and the batteries themselves become corroded, after cleansing, making them unreliable and a definite safety hazard.

My device is superior to previous products because it gives complete control, in time and space, of the maneuvers of the internal probe by the user. It produces a simple and efficient ejaculation for the user, is very hygienic, has disposable parts, easy to store and transport, simple to manufacture and does not need unreliable and unhealthy electrical parts to operate.

### DRAWINGS—FIGURES

FIG. 1 is a side view showing the slider with arrows indicating a direction of motion, the base cylinder and the anal cavity probe indicating a direction of movement.

FIG. 2 is a right side view of the base cylinder, the left view being identical.

FIG. 3 is a top view of the base cylinder.

FIG. 4 is a side cut-a-way view of the base cylinder revealing the slider inside and also the support rod which holds the anal cavity probe.

FIG. 5 is a side cut-a-way showing the slider and the support rod inside the base cylinder.

FIG. 6 is a front view showing the slider inside the base cylinder, the support rod holding the anal cavity probe sheathed in a rubber-like material which wraps around the base and locks with a Velcro type or other similar fasteners-type attachments.

FIG. 7 is a front view as in FIG. 4 showing the side tilt movement of the probe in relation to the opposite side force applied to the probe support rod beneath the top surface of the base cylinder.

FIG. 8 is a rear view showing the slider inside the base cylinder with the support rod and probe.

FIG. 9 is a side view of the slider showing the probe support rod in place.

FIG. 10 is a top view of the base cylinder with a cut-a-way section showing the slider contained within.

FIG. 11 is a bottom view of the base cylinder showing the ellipse hole cut out to allow for the bottom movement of the probe support rod.

FIG. 12 is a bottom view of the base cylinder showing the ellipse hole cut out to allow for the bottom movement of the probe support rod with the support rod in the rearward position.

FIG. 13 is a bottom view of the base cylinder showing an alternate configuration of the ellipse hole cut out to allow for the side to side bottom movement of the probe support rod.

FIG. 14 is a bottom view of the base cylinder showing an alternate configuration of the ellipse hole cut out to allow for the bottom movement of the probe support rod with the support rod in the side position.

FIG. 15 is a side view showing the slider.

FIG. 16 is a top view showing the slider with an ellipse cut out used to push the bottom of the probe support rod fore and aft within the ellipse of the bottom of the base cylinder.

FIG. 17 is a bottom view showing the slider with an ellipse cut out used to push the bottom of the probe support rod fore and aft within the ellipse of the bottom of the base cylinder.

FIG. 18 is a perspective view of the Disposable Leveraged Mechanical Prostate Massager with the probe sheathed in a rubber-like material which wraps around the base and locks with a Velcro type or other similar fasteners-type attachments, inside the anal cavity.

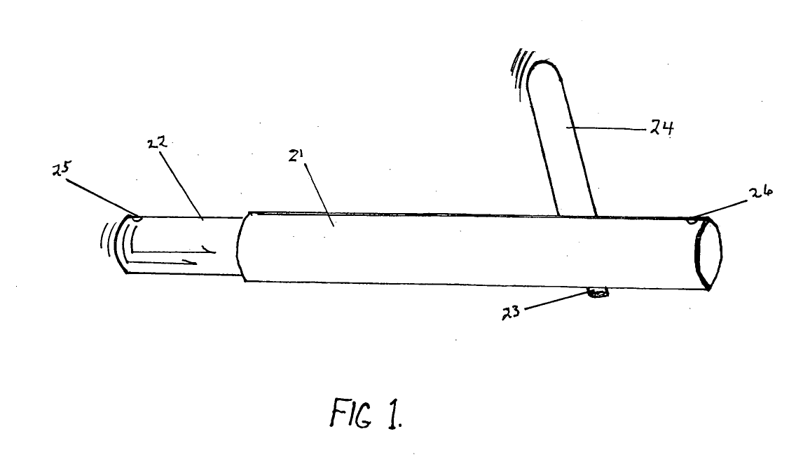

### DETAILED DESCRIPTION—FIG. 1—PREFERRED EMBODIMENT

FIG. 1 is the preferred embodiment of my invention the Disposable Leveraged Mechanical Prostate Massager. The base cylinder 21 houses the slider 22 which when sliding in and out of the base cylinder moves the base rod 23 which supports the anal probe 24 in a likewise back and forth motion. The slider 22 when twisted also moves the base rod in a side to side motion which likewise moves the anal probe in a side by side motion. A combination side by side and back and forth motion of the probe can also be attained by a combined twisting and in and out motion of the slider. Holes 25 and 26 can accommodate a strap which when looped over either shoulder of the user, and snugged tight, will hold the Disposable Leveraged Mechanical Prostate Massager in place without hand support.

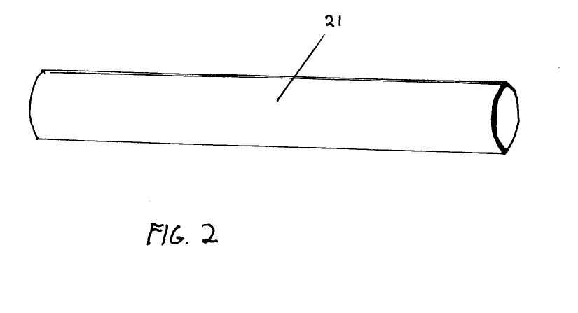

FIG. 2 is a right side view of the base cylinder 21, the left view being identical.

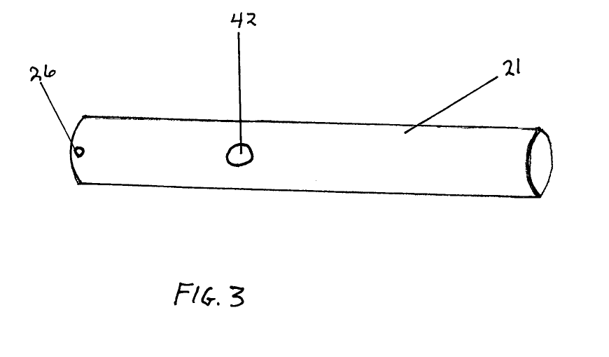

FIG. 3 is a top view of the base cylinder 21 showing the top pivot point opening 42 for the probe support rod and the rear opening for the strap attach point 26.

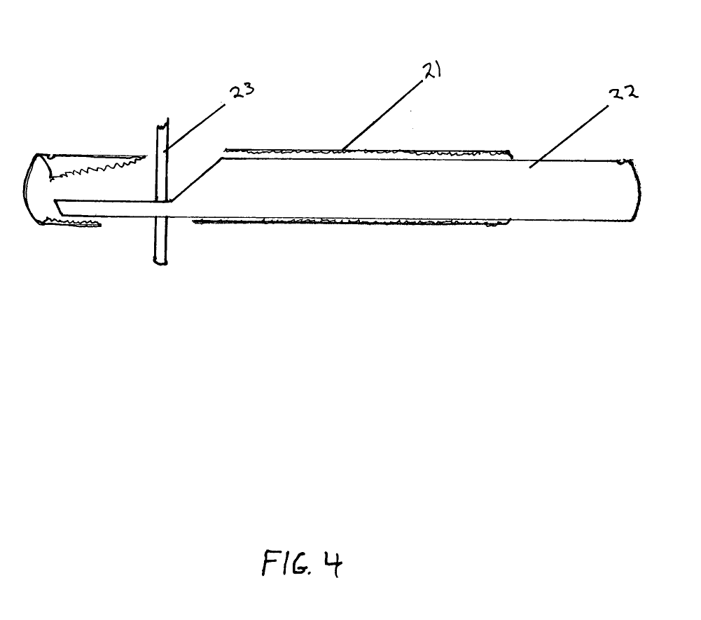

FIG. 4 shows the support rod 23 relation and point of contact with the slider 22 inside the base cylinder 21

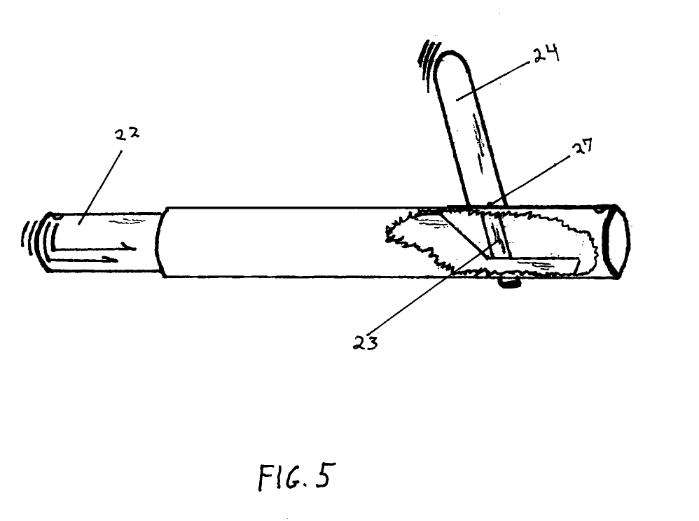

FIG. 5 shows that a push on the slider 22 moves the support rod rearward thus moving the upper support rod and probe forward. The pivot point 27 allows for leveraged movement of the upper end of the support rod 23.

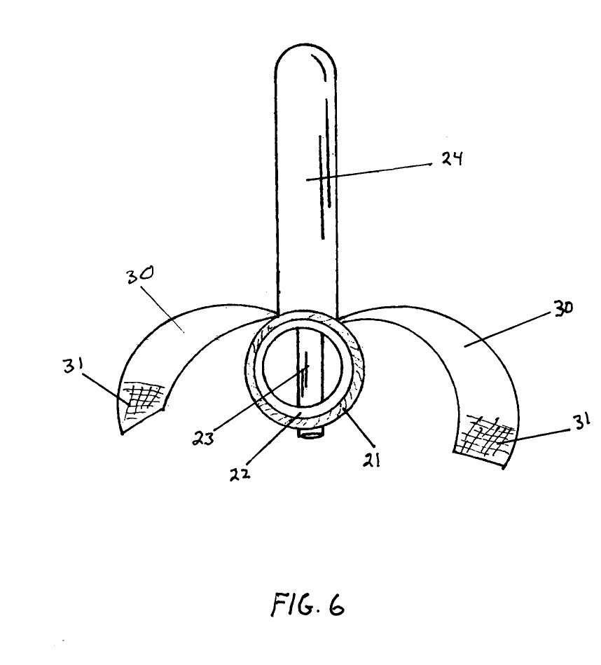

FIG. 6 is the front end view showing the base cylinder 21, the slider 22, the support rod 23 and the probe 24. A rubber-like substance sheaths the probe 24 and includes a left and right flyleaf 30 and fastened together along the bottom of the base cylinder 21 with the attached Velcro type or other similar fasteners. The rubber type material can be removed after use and disposed of or hygienically cleaned.

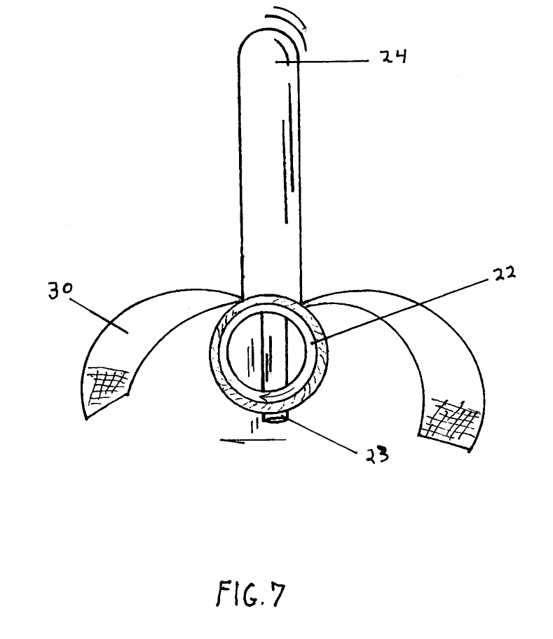

FIG. 7 shows the front view with slider 22 being twisted toward flyleaf 30 causing the probe 24 to move in the opposite direction.

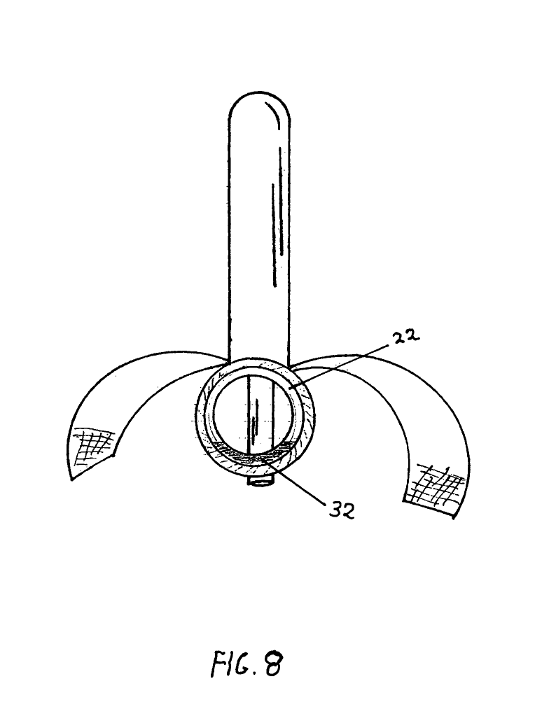

FIG. 8 shows a rear view and the tapered end 32 of the slider 22.

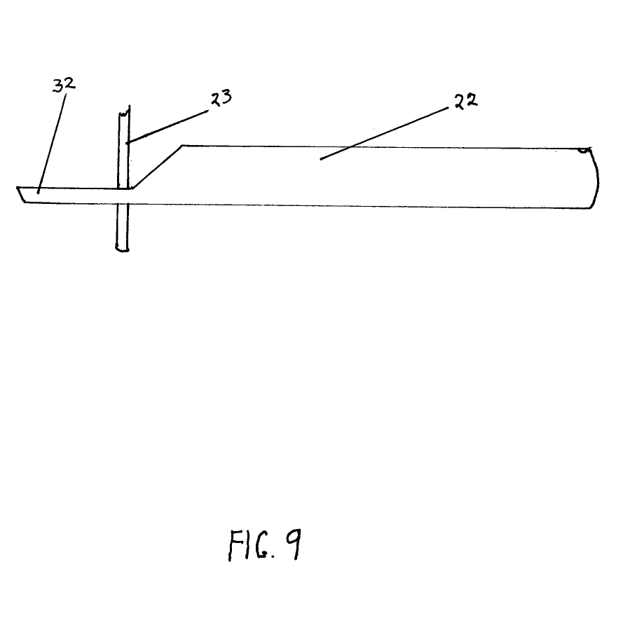

FIG. 9 shows the tapered end 32 of the slider 22 with the probe support rod 23.

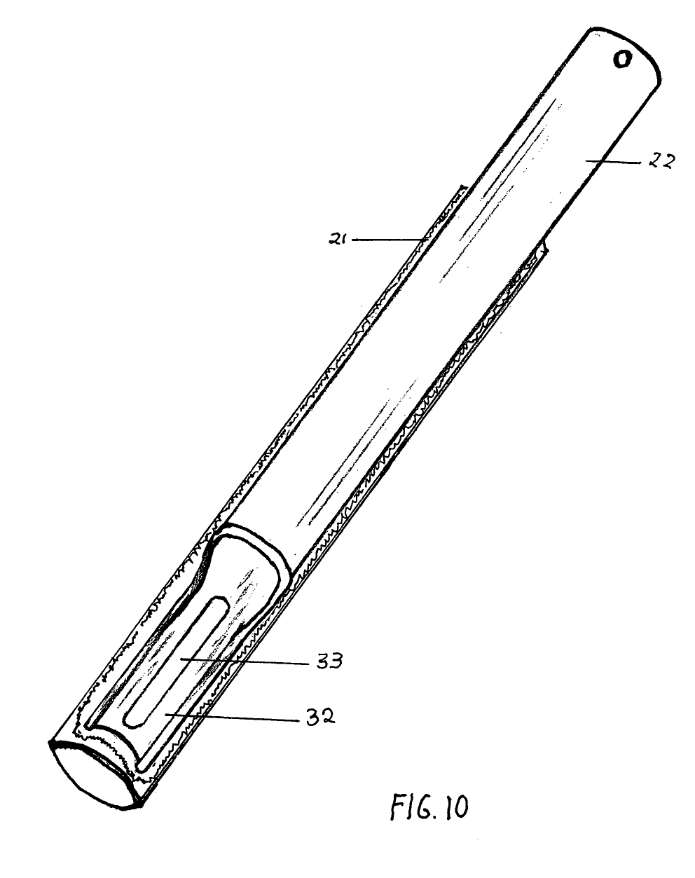

FIG. 10 shows a cut-away view of the base cylinder 21 containing the slider 22 with the tapered end 32 and the elongated hole 33 which controls the movement of the probe support rod.

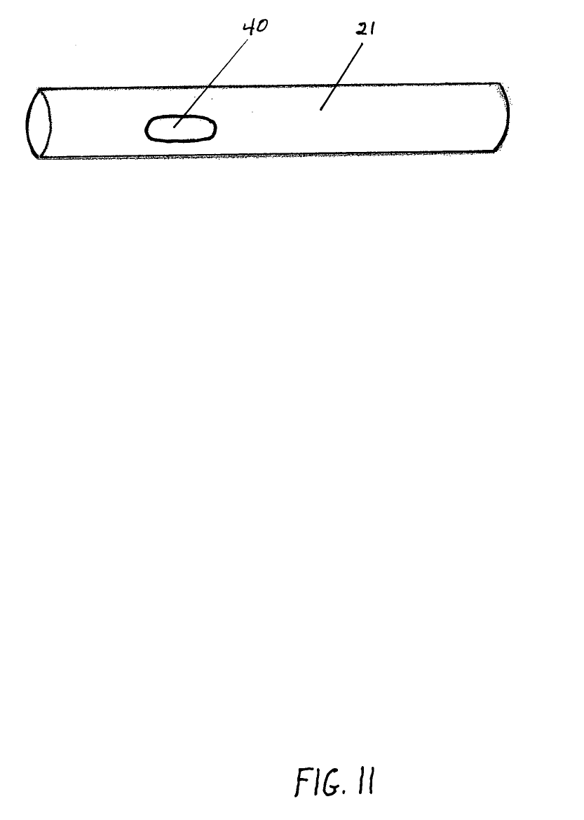

FIG. 11 shows a bottom view of the base cylinder 21 with the elongated hole 40 which allows movement of the support rod being moved by the slider.

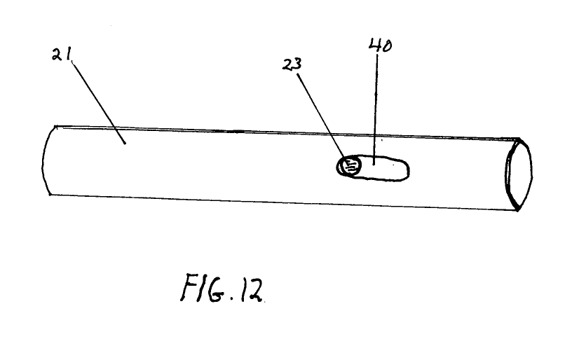

FIG. 12 shows a bottom view of the base cylinder 21 and the elongated hole 40 with the probe support rod 23 in the rearward position which would cause the probe to be in the forward leaning position.

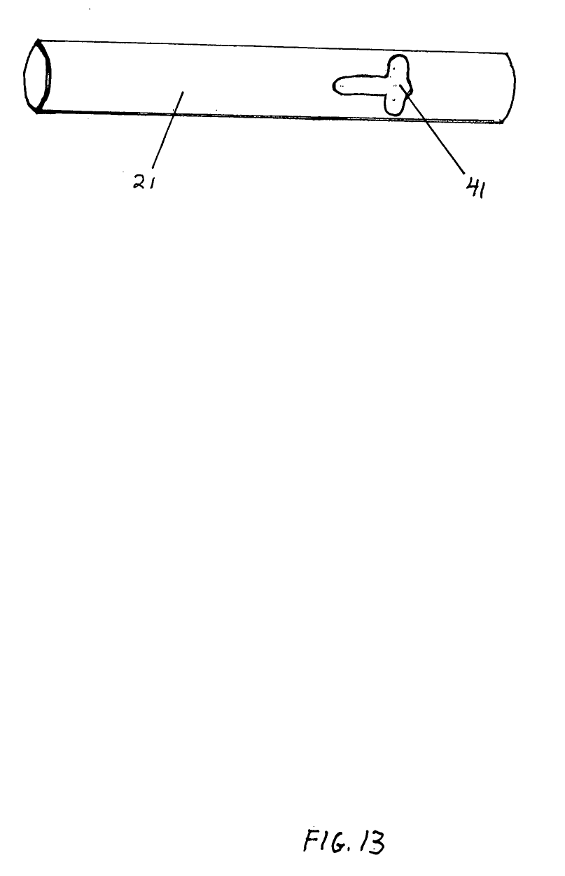

FIG. 13 shows a bottom view of the base cylinder 21 with alternate embodiment in which the elongated hole having side additional recesses 41 to allow for the twisting movement of the slider making the support rod move from side to side.

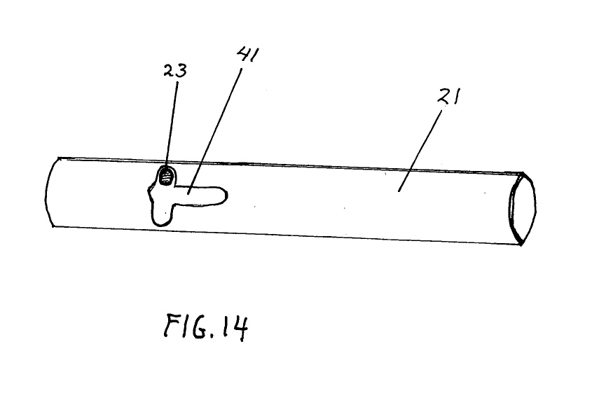

FIG. 14 shows a bottom view of the base cylinder 21 with alternate embodiment in which the elongated hole having side additional recesses 41 with the bottom of the support rod 23 in a side recessed position which would cause the probe to move to a leaning sideways position.

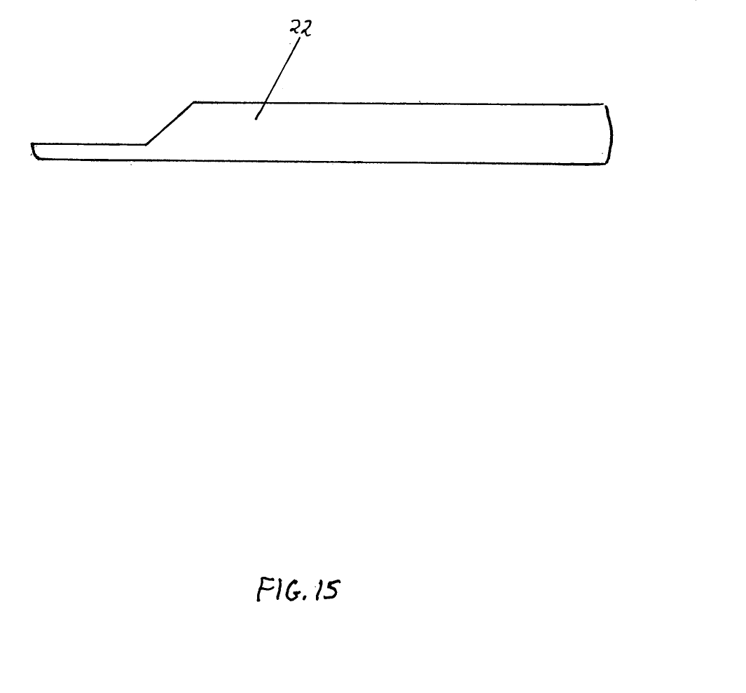

FIG. 15 show a side view of the slider 22.

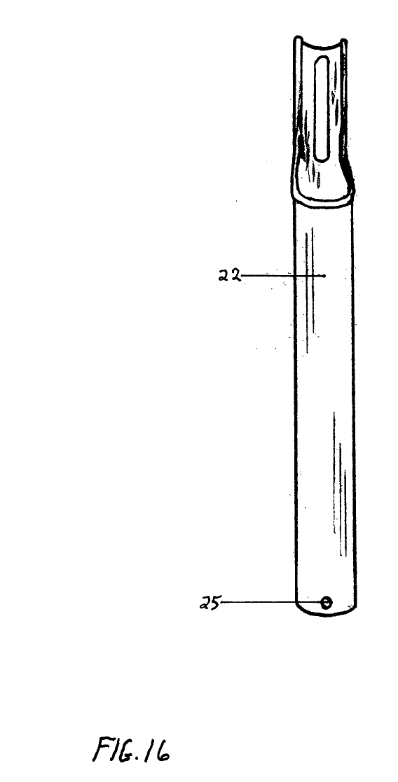

FIG. 16 shows a top view of the slider 22 with accommodating opening 25 for strap.

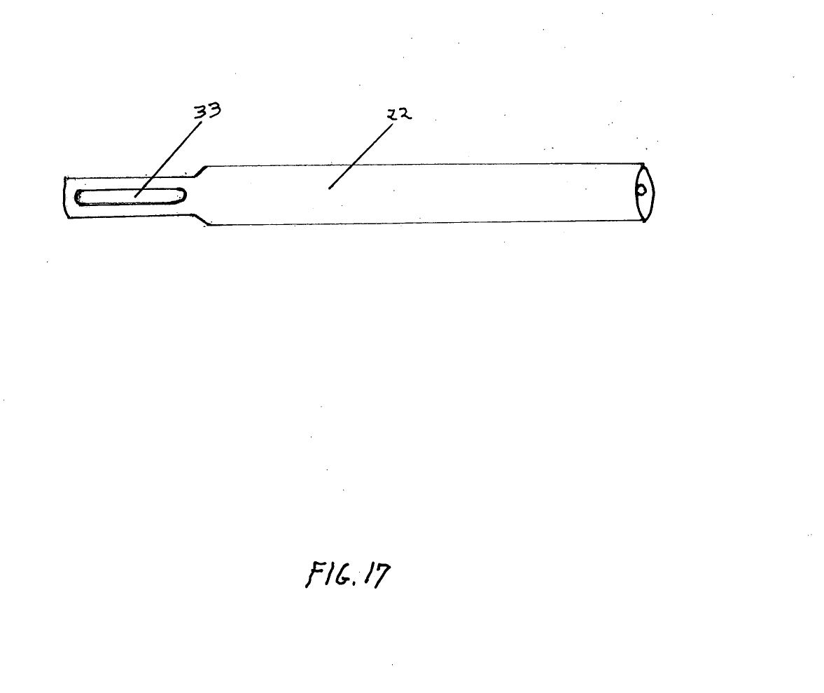

FIG. 17 shows bottom view of slider 22 with elongated opening 33 to accommodate and move the support rod.

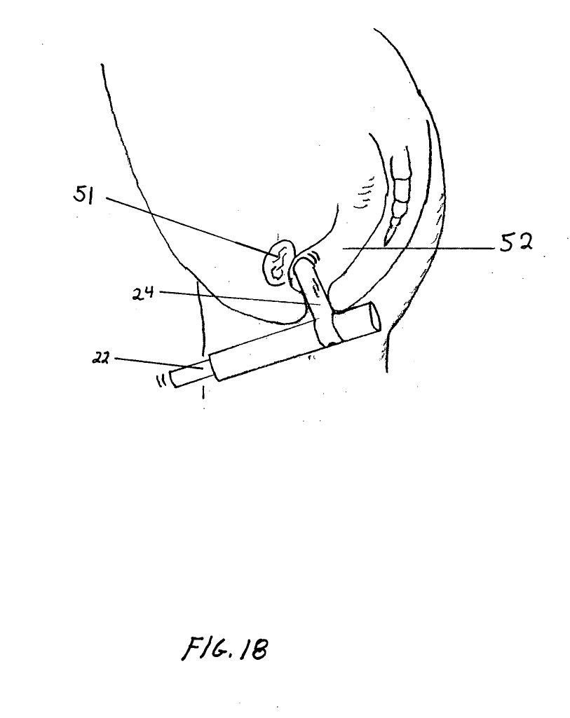

FIG. 18 shows the placement of the probe 24 in the anal cavity 52 and movement of the slider 22 in and out causing the probe to move fore and aft causing intermittent pressure against the prostate gland 51.

I claim:

1. A disposable, leveraged mechanical prostate massager, comprising:
A base cylinder supporting an anal probe rod passing through an opening on the top surface of the cylinder and passing through an opening in the bottom surface of the cylinder;
Base cylinder contains a smaller additional opening on the top surface to attach an adjustable strap;
Base cylinder contains a smaller diameter cylinder, known as the slider containing an opening on the one end top surface to attach the other end of the strap from the base cylinder;
The slider, of slightly less diameter than the inside of the base cylinder, having an elongated opening on the bottom surface, lining up with the bottom opening of the base cylinder and through which both openings passes the support rod of the anal probe, the support rod passing, also through the larger of the openings on the top surface of the base cylinder;
The support rod of the probe pivots around the bottom surface of the top opening of the base cylinder when moved by the slider;
The upper end of support rod, supporting the anal probe, pivots fore and aft when the slider's elongated opening guides the lower extremity of the support rod aft and fore;
The upper end of the support rod, supporting the anal probe, moves in opposite direction of the movement of the slider guiding the lower end of the support rod;
The upper end of the support rod, supporting the anal probe, moves in a greater arc and distance than the arc and distance of the lower extremity being guided by the elongated opening of the slider;
The leveraged effect of the pivot point of the support rod being closer to the elongated opening of the slider than to the upper end, supporting the anal probe, causes the upper end to swing in a larger arc than the arc being guided by the slider;
The forward end of the slider, when twisted causes the upper end of the support rod, supporting the anal probe, to arc side to side;
The leveraged effect of the pivot point of the support rod being closer to the elongated opening of the slider than to the upper end, supporting the anal probe, causes the upper end to swing in a larger side by side arc than the arc being guided by the slider.

2. A disposable, leveraged mechanical prostate massager possessing a disposable probe and sanitary covering on the anal probe, said covering applied and removable quickly with Velcro type or other similar fasteners;
A disposable covering of elastic properties, when secured about the base cylinder promotes repositioning of the support rod, supporting the anal probe, to an at rest position when any fore, aft or twisting force on the forward end of the slider is terminated by the user;
A disposable covering of elastic properties, which can contour to variable creative shapes of the anal probe contained within.
